(19) United States
(12) Patent Application Publication
(10) Pub. No.: US 2015/0229130 A1
(43) Pub. Date: Aug. 13, 2015

(54) ENERGY MANAGEMENT APPARATUS, ENERGY MANAGEMENT SYSTEM, AND METHOD OF CONTROLLING ENERGY MANAGEMENT SYSTEM

(71) Applicant: KYOCERA CORPORATION, Kyoto (JP)

(72) Inventor: Takeshi Yamane, Yokohama-shi (JP)

(73) Assignee: KYOCERA CORPORATION, Kyoto (JP)

(21) Appl. No.: 14/419,823

(22) PCT Filed: Aug. 2, 2013
(86) PCT No.: PCT/JP2013/004709

§ 371 Date: Feb. 5, 2015

(30) Foreign Application Priority Data
Aug. 6, 2012 (JP) 2012-174054

(51) Int. Cl. H02J 3/00; G05B 15/02

(52) U.S. Cl. CPC H02J 3/005; G05B 15/02

(57) ABSTRACT

An energy management apparatus capable of taking an appropriate measure in the event of a power outage, an energy management system, and a method of controlling the energy management system will be provided. A power input unit (112) for receiving power supply from a grid power source (50) and a control unit (114) for notifying, when there is no power supply to the power input unit (112) from the grid power source (50), a communication terminal (12) of power outage information are provided.

### CROSS REFERENCE TO RELATED APPLICATION

This application claims priority to and the benefit of Japanese Patent Application No. 2012-174054 (filed on Aug. 6, 2012), the entire contents of which are incorporated herein by reference.

### TECHNICAL FIELD

The present invention relates to an energy management apparatus, an energy management system, and a method of controlling the energy management system.

### BACKGROUND ART

In recent years, there is known a technique that, by using an energy management apparatus (for example, HEMS: Home Energy Management System) provided to each power consumer's facility, controls a load apparatus and a distributed power source that are provided to a power consumer's facility (see Patent Document 1).

### RELATED ART DOCUMENT

### Patent Document

Patent Document 1: Japanese Patent Application Laid-Open Publication No. 2003-309928

### SUMMARY OF INVENTION

### Technical Problem

Here, in the event of a power outage, power supply to the energy management apparatus and the load apparatus stops. When the energy management system is provided with the distributed power source, the distributed power source may be controlled to supply power during the power outage. As a measure to be taken in the event of the power outage, however, the power supply from the distributed power source alone is inadequate. Therefore, an appropriate measure to be taken in the event of the power outage has been desired.

Accordingly, an object of the present invention in view of the above problem is to provide an energy management apparatus capable of taking an appropriate measure in the event of the power outage, an energy management system, and a method of controlling the energy management system.

### Solution to Problem

In order to solve the above problem, an energy management apparatus according to the present invention is an energy management apparatus provided to a consumer's facility in order to manage a power state of a load apparatus or a distributed power source in the consumer's facility, the energy management apparatus including:

a power input unit for receiving power supply; and

a control unit, when there is no power supply to the power input unit from a grid power source, for notifying a communication terminal of power outage information.

The energy management apparatus according to the present invention, wherein

the power input unit receives power supply from the distributed power source when there is no power supply to the power input unit from the grid power source, and

the control unit, after start of the power supply from the distributed power source, notifies the communication terminal of the power outage information.

The energy management apparatus according to the present invention, wherein

the power input unit receives the power supply from the distributed power source, and

the control unit shuts down the energy management apparatus when there is no power supply to the power input unit from the grid power source, and then restarts the energy management apparatus by using the power supply from the distributed power source.

The energy management apparatus according to the present invention, further including a capacitor that is charged by using the power supply from the grid power source and having a capacity that allows for power supply at least during an operation of the shutdown.

The energy management apparatus according to the present invention, wherein

the power input unit receives the power supply from the distributed power source, and

the control unit, based on power outage state information from the distributed power source, notifies the communication terminal of the power outage information.

The energy management apparatus according to the present invention, wherein

the control unit, based on the power outage state information, further notifies the communication terminal of power restoration information.

The energy management apparatus according to the present invention, wherein

the control unit shuts down the energy management apparatus when there is no power supply to the power input unit from the grid power source and, after power restoration, notifies the communication terminal of the power outage information.

The energy management apparatus according to the present invention, further including a storage unit, wherein

the control unit stores a power outage flag in the storage unit during the operation of the shutdown and, after power restoration, notifies the communication terminal of the power outage information based on the power outage flag.

The energy management apparatus according to the present invention, further including a capacitor that is charged by using the power supply from the grid power source and having a capacity that allows for power supply at least during the operation of the shutdown.

An energy management system according to the present invention including an energy management apparatus provided to a consumer's facility in order to manage a power state of a load apparatus or a distributed power source in the consumer's facility and also including a communication terminal,

the energy management apparatus, when there is no power supply from a grid power source, transmitting power outage information to the communication terminal, and

the communication terminal, when receiving the power outage information, displaying an indication based on the power outage information.

A method of controlling an energy management system according to the present invention is a method of controlling an energy management system including an energy management apparatus provided to a consumer's facility in order to manage a power state of a load apparatus or a distributed power source in the consumer's facility and also including a communication terminal, the method including:

a step of transmitting, by the energy management apparatus, power outage information to the communication terminal when there is no power supply from a grid power source; and

a step of displaying, by the communication terminal, an indication based on the power outage information when the communication terminal receives the power outage information.

### Effect of the Invention

According to the energy management apparatus, the energy management system, and the method of controlling the energy management system of the present invention, the communication terminal may be notified of the power outage information as an appropriate measure taken in the event of the power outage.

### BRIEF DESCRIPTION OF DRAWINGS

FIG. 1 is a block diagram illustrating a schematic configuration of an energy management system according to a first embodiment;

FIG. 2 is a functional block diagram illustrating a schematic configuration of an energy management apparatus according to the first embodiment;

FIG. 3 is a functional block diagram illustrating a schematic configuration of a communication terminal according to the first embodiment;

FIG. 4 is a flowchart illustrating an operation of the energy management system according to the first embodiment;

FIG. 5 is a block diagram illustrating a schematic configuration of an energy management system according to a second embodiment;

FIG. 6 is a functional block diagram illustrating a schematic configuration of an energy management apparatus according to the second embodiment; and

FIG. 7 is a flowchart illustrating an operation of the energy management system according to the second embodiment.

### DESCRIPTION OF EMBODIMENTS

Hereinafter, embodiments of the present invention will be described.

### First Embodiment

First, an energy management system according to a first embodiment will be described. The energy management system according to the present embodiment includes a distributed power source in order to receive power supply therefrom in addition to power supply from a power system (a grid power source). The distributed power source includes, for example, a battery system capable of storing and discharging power. According to the present embodiment, hereinafter, an example having a battery unit as the battery system will be described.

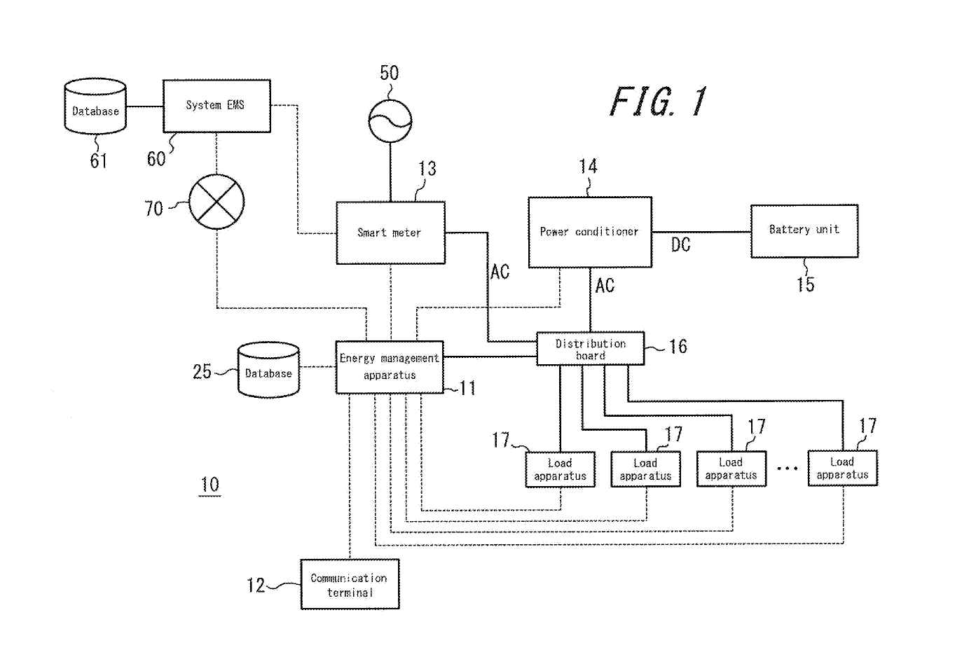

FIG. 1 is a block diagram illustrating a schematic configuration of an energy management system 10 according to the first embodiment of the present invention. The energy management system 10 according to the first embodiment of the present invention includes an energy management apparatus 11, a communication terminal 12, a smart meter 13, a power conditioner 14, a battery unit 15, a distribution board 16, and load apparatuses 17.

In FIG. 1, a solid line connecting functional blocks represents a power flow. In FIG. 1, also, a broken line connecting functional blocks represents a flow of a communication of a control signal or information. The communication indicated by the broken line may be a wired communication or a radio communication. The radio communication is carried out via a wireless router. The wireless router may be incorporated in the energy management apparatus 11, or provided separately therefrom.

For the communication of the control signal and the information, a variety of methods including a physical layer and a logical layer may be employed. For example, a communication among the energy management device 11, the communication terminal 12, the smart meter 13, and the power conditioner 14 may employ a short-distance communication method such as ZigBee (registered trademark). Also, a communication between the energy management apparatus 11 and the load apparatus 17 may employ various transmission media including an infrared communication, a power line communication (PLC: Power Line Communication), and the like. Further, on the physical layer applicable to each communication, various communication protocols including ZigBee SEP2.0 (Smart Energy Profile2.0), ECHONET Lite (registered trademark), and the like those specifying the logical layer alone may be operated. Hereinafter, an example where the energy management apparatus 11 employs ECHONET Lite (registered trademark) for the communication with the communication terminal 12, the smart meter 13, the power conditioner 14, and the load apparatus 17 will be described.

The energy management system 10 may supply, other than the power supplied from a grid power source 50, power discharged out of power stored in the battery unit 15 to the load apparatuses 17 and the energy management apparatus 11.

The energy management apparatus 11 controls and manages power of each apparatus in the energy management system 10 illustrated in FIG. 1. A configuration of the energy management apparatus 11 will be described in detail later.

The communication terminal 12 displays information transmitted by the energy management apparatus 11. For example, the communication terminal 12 displays information on power consumption and the like. As described later, also, upon receiving notification of power outage information from the energy management apparatus 11, the communication terminal 12 displays an icon (hereinafter, referred to as a power outage icon) indicating that there is a power outage or that there was a power outage. Similarly, upon receiving notification of power restoration information from the energy management apparatus 11, the communication terminal 12 displays an icon (hereinafter, referred to as a power restoration icon) indicating that power has been restored. A configuration of the communication terminal 12 will be described in detail later. It is a matter of course that, instead of the icons, other expression methods such as a character string and the like may be displayed.

The smart meter 13 is connected to the grid power source 50 and measures power supplied therefrom. Also, the smart meter 13 may obtain information such as, for example, a prediction about power and the like from a system EMS (Energy Management System) 60. Here, the system EMS 60 is an equipment for carrying out various predictions and control in association with power and generally installed in a power company. As the system EMS 60, one constituting, for example, MDMS (Meter Data Management System) may be employed. The system EMS 60 includes a database 61 for storing various information on power and may collect and store information on a result of the measurement carried out by the smart meter 13. Also, the system EMS 60 may be connected to a network 70, which is an external network such as the Internet.

The power conditioner 14 converts DC power supplied from the battery unit 15 into AC power. Also, the power conditioner 14 supplies the AC power to each of the load apparatuses 17 via a plurality of branches branched off from the distribution board 16. Further, the power conditioner 14 may convert AC power supplied from the grid power source 50 into DC power to charge the battery unit 15.

The battery unit 15 includes a battery and may supply power by discharging power stored in the battery. Also, the battery unit 15 may store the power supplied from the grid power source 50. As illustrated in FIG. 1, the power discharged from the battery unit 15 may be supplied to each of the load apparatuses 17 and the energy management apparatus 11. In order to supply the power discharged from the battery unit 15 to the energy management apparatus 11 and each of the load apparatuses 17, power supply is switched over from the power supplied from the grid power source 50 to the power discharged from the battery unit 15.

Also, the battery unit 15 determines whether the power supply from the grid power source 50 is stopped, that is, whether there is a power outage, and generates information about whether there is a power outage (hereinafter, referred to as power outage state information). Further, the battery unit 15 transmits the power outage state information to the energy management apparatus 11.

The distribution board 16 separates supplied power into a plurality of branches and distributes thus separated power to each of the load apparatuses 17. Here, some branches are directly connected to typical load apparatuses 17 of high power consumption, and others are summarized in each room. The load apparatuses 17 connected to the former branches are, for example, an air conditioning, a refrigerator, an induction heating (IH) cooker, and the like. The load apparatuses 17 connected to the latter branches are indefinite load apparatuses connected to outlets installed in each room.

In FIG. 1, any number of the load apparatuses 17 may be connected to the energy management system 10. These load apparatuses 17 are various electrical appliances such as, for example, a TV set, the air conditioning, the refrigerator, and the like. These load apparatuses 17 are connected to the power conditioner 14 via the distribution board 16 in order to receive power supply.

Next, the energy management apparatus 11 according to the first embodiment will be further described.

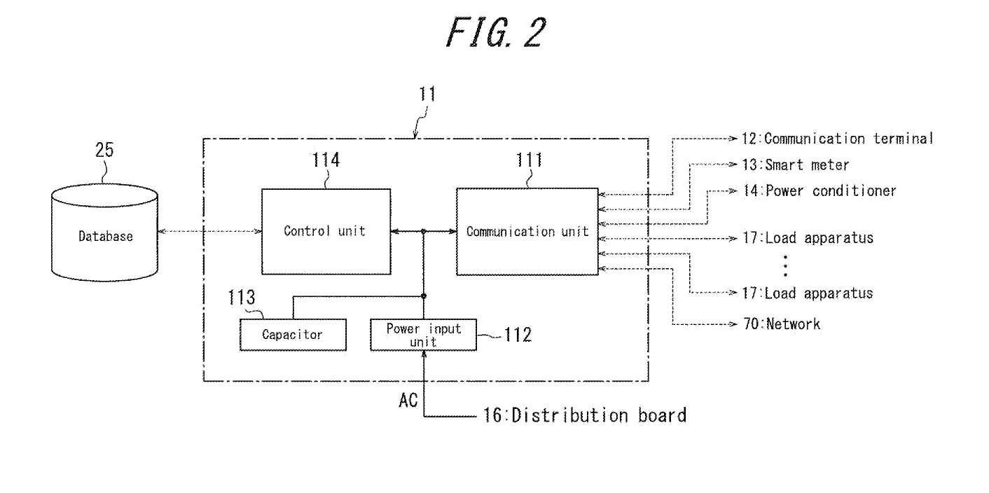

FIG. 2 is a functional block diagram illustrating a schematic configuration of the energy management apparatus 11 according to the present embodiment. The energy management apparatus 11 is, for example, HEMS and includes a communication unit 111, a power input unit 112, a capacitor 113, and a control unit 114.

The communication unit 111 is, for example, an interface and exchanges the control signal and various information from the control unit 114 in communication with the communication terminal 12, the smart meter 13, the power conditioner 14, and the load apparatuses 17.

For example, the communication unit 111 may receive, from the smart meter 13, power purchased from the grid power source 50 and/or power sold thereto. Also, the communication unit 111 may obtain information on a demand response (Demand Response: DR) from, for example, the power company via the smart meter 13. Also, the communication unit 111 may receive, from the power conditioner 14, the power supplied from the battery unit 15 and the grid power source 50 to the load apparatus 17 through the plurality of branches branched off from the distribution board 16, via a sensor provided to each of the branches. Also, the communication unit 111 may directly obtain, from the power conditioner 14, an amount of the power stored (i.e., stored power) in the battery unit 15. Also, the communication unit 111 may directly obtain power consumption from each of the load apparatuses 17. Also, the communication unit 111 may obtain various information from the network 70.

Further, the communication unit 111 may receive the control signal from the communication terminal 12 and notifies the communication terminal 12 of information about a state of control and management of power conducted by the energy management system 10. By way of example, an example employing ECHONET LITE (registered trademark) will be described.

The power input unit 112 receives power supply from the grid power source 50 and the battery unit 15 via the smart meter 13 and the distribution board 16.

The capacitor 113 may be, for example, a super capacitor and charged by using the power supply received by the power input unit 112 (that is, the power supply from the grid power source 50 and the like). The capacitor 113, when the power supply from the grid power source 50 to the power input unit 112 is stopped due to a power outage, discharges the power stored in the capacitor 113 itself and, in place of the grid power source 50, supplies power to the energy management apparatus 11. That is, the capacitor 113 serves as a backup power source for temporarily supplying the power during the power outage. Therefore, the capacitor 113, during the power outage, allows the energy management apparatus 11 to continue an operation for a predetermined period within a range of the power stored in the capacitor 113. That is, as described later, the energy management apparatus 11 carries out a shutdown operation within the range of the power stored in the capacitor 113.

The control unit 114, based on the various information obtained by the communication unit 111, generates the control signal for controlling the power supplied to each apparatus in the energy management system 10 and/or the information to be transmitted to the communication terminal 12.

Also, the control unit 14, in order to manage the power supplied to each apparatus in the energy management system 10, stores the information obtained by the communication unit 111. The control unit 114 includes a database 25 for storing various information collected. The database 25 may be any storage device and the like and either externally connected to the energy management apparatus 11 or incorporated therein.

Further, the control unit 114 monitors the power supply to the power input unit 112 from the grid power source 50 and determines the presence/absence of the power supply. The communication terminal 114, when the power supply is stopped, notifies the communication terminal 12 of information about a power outage (hereinafter, referred to as the power outage information) via the communication unit 111.

In particular, the control unit 114, when there is no power supply to the power input unit 112 from the grid power source 50, determines that there is a power outage. At this time, the energy management apparatus 11 operates by using the power supplied from the capacitor 113 and, first, carries out the shutdown operation of the energy management apparatus 11. At this time, also, the energy management apparatus 11 changes over the power supply from the grid power source 50 to the battery unit 15. That is, by using ECHONET Lite (registered trademark), the energy management apparatus 11 transmits a specific code for notifying about the power outage to the battery unit 15 and also transmits a specific code for instructing the changeover of the power source from the grid power source 50 to the battery unit 15.

The control unit 114, by using the power supplied from the battery unit 15 after the shutdown, resumes the operation of the energy management apparatus 11, that is, carries out a restart operation. After the restart operation, the control unit 114, from the battery unit 15, by using ECHONET Lite (registered trademark), obtains the code of the power outage state information. Then, the control unit 114, based on the code of the power outage state information, determines whether there is a power outage. The control unit 114, based on the determination, notifies the communication terminal 12 via the communication unit 111 of the power outage information or information about power restoration (hereinafter, referred to as the power restoration information) by using a specific code prescribed in ECHONET Lite (registered trademark). Here, the power outage information may be the power outage state information, or information including processed power outage state information. For example, the control unit 114 may retain information about time to have obtained the power outage state information and include the information about the time in the power outage information. Similarly, the power restoration information may be the power outage state information, or information including processed power outage state information. For example, the control unit 114 may retain information about time to have obtained the power outage state information and include the information about the time in the power restoration information.

Here, the control unit 114 cannot transmit the notification to the communication terminal 12 by using the radio communication via the communication unit 111 because, immediately after the start of the power outage, the wireless router stops operating due to the power outage. However, when the power supply is changed over from the grid power source 50 to the battery unit 15, that is, after the restart of the energy management apparatus 11, the wireless router may operate by using the power supplied from the battery unit 15 and allow for the communication.

Preferably, the control unit 114 transmits the notification to the communication terminal 12 by using a code based on a code assignment of abnormality contents prescribed in a standard of ECHONET Lite (registered trademark). Also preferably, the control unit 14 carries out multicast transmission for the notification. ECHONET Lite (registered trademark) includes assignments of a number of codes of various states including, for example, abnormality. For the power outage information and the power restoration information, a code in a user-defined region included in a classification of recoverable abnormal is used. To the power outage information, for example, a code having “0x09” at a lower 1 byte of the code of the abnormality contents and “0x00” at a higher 1 byte of the code of the abnormality contents is assigned. To the power restoration information, on the other hand, a code having “0x09” at the lower 1 byte of the code of the abnormality contents and “0x04” at the higher 1 byte of the code of the abnormality contents is assigned.

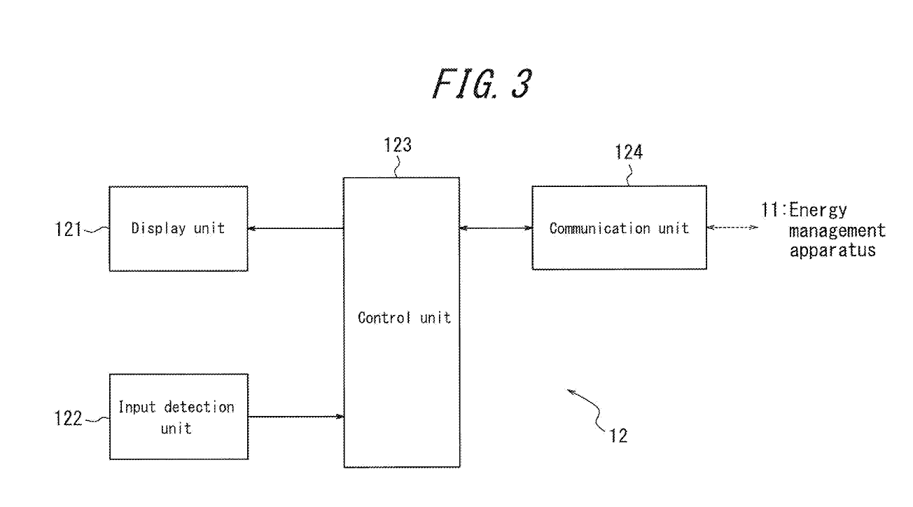

FIG. 3 is a functional block diagram illustrating a schematic configuration of the communication terminal 12 according to the first embodiment. The communication terminal 12 may be a variety of terminals such as a specially designed terminal, a mobile terminal, a personal computer (PC), a laptop computer, a tablet PC having application software installed therein, and the like. The communication terminal 12 includes a display unit 121, an input detection unit 122, a control unit 123, and a communication unit 124.

The display unit 121 may be, for example, a liquid crystal display (LCD), an organic EL display, or the like. Although the display unit 121 according to the present embodiment may be either a gray-scale display or a monochromatic display, the display unit 121, in order to display in such a manner as to allow general users to easily grasp contents at first glance, preferably handles a color display.

The display unit 121 displays the information on the power consumption and the like received from the energy management apparatus 11. When the display unit 121, under the control of the control unit 123, receives the notification of the power outage information or the notification of the power restoration information from the energy management apparatus 11 via the communication unit 124, displays the power outage icon or the power restoration icon. Also, the display unit 121 may display an image for receiving various inputs to execute functions of the energy management apparatus 11.

The input detection unit 122 detects an input corresponding to the display of the display unit 121. The input detection unit 122 may be, for example, a touch panel and may detect an operation by a user directly contacting the touch panel with the user's finger or the like. Also, the input detection unit 122 may detect multi-touch, that is, contacts to a plurality of positions on a contact detection surface of the input detection unit 122.

The touch panel is made of a transparent member and disposed on a front face of the display unit 121. Thereby, the touch panel may detect a contact to an object such as the icon displayed on the display unit 121. Accordingly, the input detection unit 122 constituted by using the touch panel as described above may allow the user to intuitively operate. Note that, instead of the touch panel, an operation means including a physical key may be employed as the input detection unit 122.

The control unit 123, by controlling each functional unit constituting the communication terminal 12, controls and manages the entire communication terminal 12.

The communication unit 124 is, for example, the interface and carries out the wired communication or the radio communication with the energy management apparatus 11. That is, the communication unit 124 transmits the control signal and/or the information to the energy management apparatus 11 and receives the control signal and/or the information from the energy management apparatus 11. The communication unit 124, when the communication terminal 12 carries out the wired communication to communicate with the energy management apparatus 11, may function as a receptacle of a connecter for connecting a cable connected to the energy management apparatus 11 to the communication terminal 12.

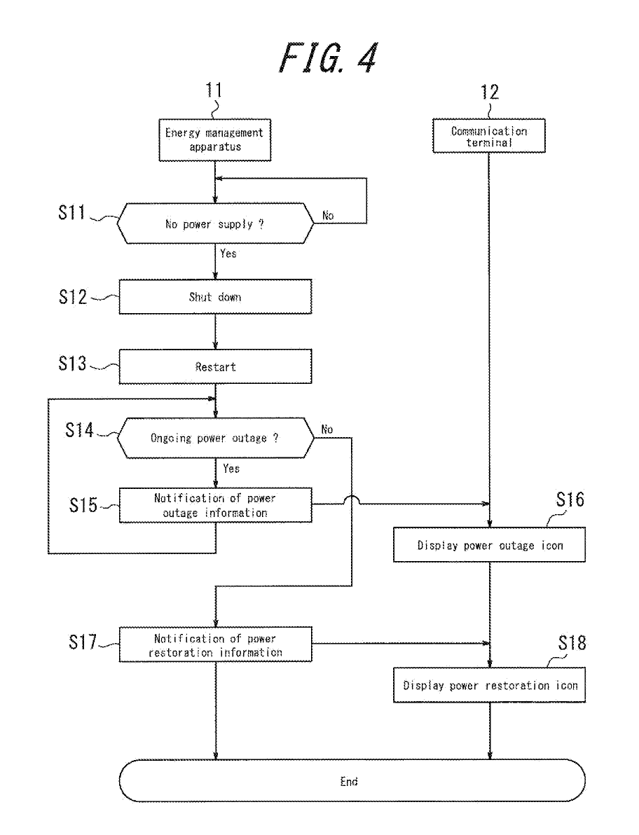

Next, an operation of the energy management system 10 according to the first embodiment will be described with reference to a flowchart illustrated in FIG. 4.

First, the control unit 114 of the energy management apparatus 11 monitors the power supply to the power input unit 112 from the grid power source 50 and determines the presence/absence of the power supply (step S11). When there is no power supply, the control unit 114 proceeds to step S12. On the other hand, when there is the power supply, the control unit 114 repeats step S11.

When there is no power supply, the control unit 114 determines that there is a power outage. At this time, the energy management apparatus 11 operates by using the power supplied from the capacitor 113, and the control unit 114 carries out the shutdown operation of the energy management apparatus 11 (step S12). At this time, also, the energy management apparatus 11 changes over the power supply from the grid power source 50 to the battery unit 15.

Subsequently, the control unit 114, by using the power supplied from the battery unit 15 after the shutdown, resumes the operation of the energy management apparatus 11, that is, carries out the restart operation (step S13).

Next, the control unit 114 obtains the power outage state information from the battery unit 15 and determines whether there is the power outage (step S14). When the control unit 114 determines that there is the power outage, the control unit 114 proceeds to step S15. On the other hand, when the control unit 114 determines that there is no power outage (that the power is restored), the control unit 114 proceeds to step S17.

When the control unit 114 determines that there is the power outage at step S14, the control unit 114 notifies the communication terminal 12 of the power outage information via the communication unit 111 (step S15). In particular, the control unit 114, as the power outage information, notifies the communication terminal 12 that there is the power outage. The control unit 123 of the communication terminal 12, upon receiving the notification of the power outage information via the communication unit 124, controls the display unit 121 to display the power outage icon (step S16). Then, the control unit 114 returns to step S14.

When the control unit 114 determines that there is no power outage at step S14, the control unit 114 notifies the communication terminal 12 of the power restoration information (step S17). At this time, the energy management apparatus 11 changes over the power supply from the battery unit 15 to the grid power source 50. The control unit 123 of the communication terminal 12, upon receiving the notification of the power restoration information via the communication unit 124, controls the display unit 121 to display the power restoration icon (step S18). Here, the control unit 123, when the power outage icon is displayed, displays the power restoration icon erasing the power outage icon.

According to the first embodiment of the present invention, as described above, since the energy management apparatus 11 detects a power outage and notifies the communication terminal 12 of the power outage information, the communication terminal 12 may be notified of the power outage information as an appropriate measure to be taken in the event of a power outage. Also, such notification of the power outage information may allow the user to recognize that the power is supplied from the battery unit 15 in place of the grid power source 50 and prompt the user to reduce the power consumption during the power outage.

Although at step S16 the control unit 123 of the communication terminal 12, when the power outage icon is displayed, displays the power restoration icon erasing the power outage icon, the present invention is not restrictive thereto. The control unit 123, when the power outage icon is displayed, may display the power restoration icon leaving the power outage icon displayed. Thereby, the user may recognize that there was a power outage occurred in the past and check, for example, whether a recording program of a video deck or time setting of the air conditioning has been cancelled.

### Second Embodiment

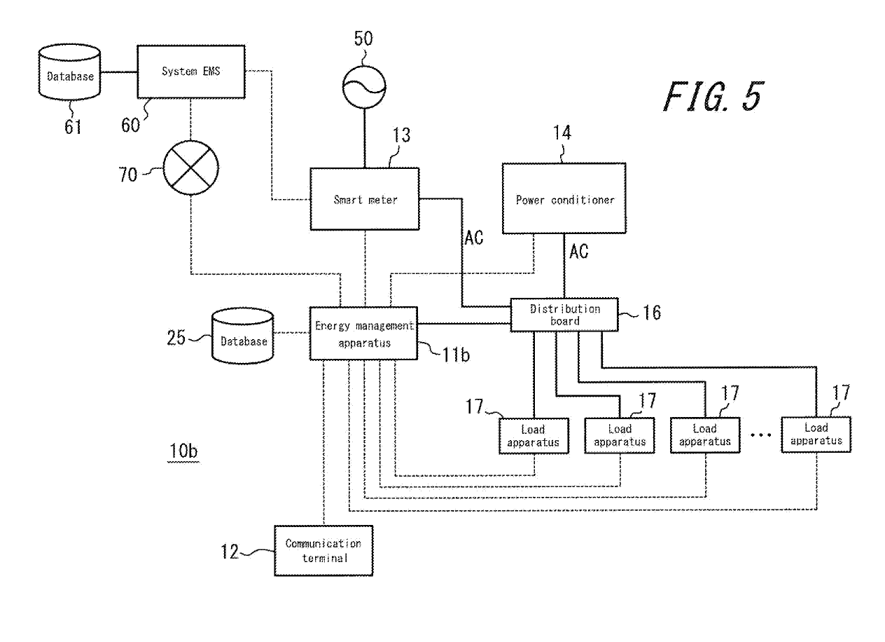

Hereinafter, a second embodiment of the present invention will be described. FIG. 5 is a block diagram illustrating a configuration of an energy management system 10b according to the second embodiment of the present invention. Components the same as those of the energy management system 10 according to the first embodiment are denoted by the same reference signs, and descriptions thereof are omitted. The energy management system 10b according to the second embodiment is different from the energy management system 10 according to the first embodiment in terms of the absence of the battery unit 15 and a configuration of an energy management apparatus 11b.

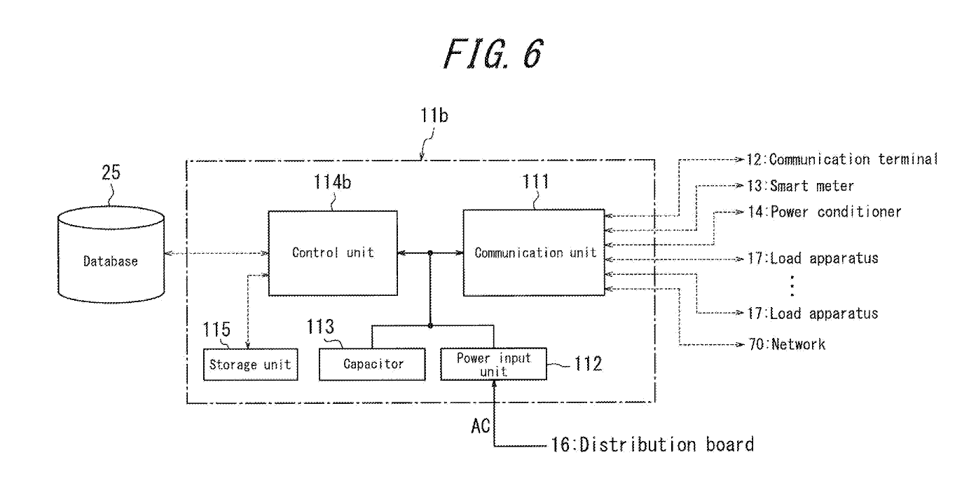

FIG. 6 is a functional block diagram illustrating a schematic configuration of the energy management apparatus 11b according to the second embodiment. Components the same as those of the energy management apparatus 11 according to the first embodiment are denoted by the same reference signs, and descriptions thereof are omitted. The energy management apparatus 11b according to the second embodiment is different from the energy management apparatus 11 according to the first embodiment in terms of the presence of a storage unit 115 and controls conducted by a control unit 114b.

The energy management apparatus 11b is, for example, the HEMS and includes the communication unit 111, the power input unit 112, the capacitor 113, the control unit 114b, and the storage unit 115.

The control unit 114b monitors the power supply to the power input unit 112 from the grid power source 50 and determines the presence/absence of the power supply. The control unit 114b, when there is no power supply to the power input unit 112 from the grid power source 50, determines that there is a power outage. At this time, the energy management apparatus 11b operates by using the power supplied from the capacitor 113 and carries out a shutdown operation of the energy management apparatus 11b. Also, the control unit 114b, during the shutdown operation, stores a flag indicating the power outage (hereinafter, referred to as a power outage flag) in the storage unit 115.

The control unit 114b, when the power is restored, restarts the energy management apparatus 11b and then refers to the storage unit 115. The energy management apparatus 11b notifies the communication terminal 12 of the power outage information about the power outage occurred in the past based on the power outage flag.

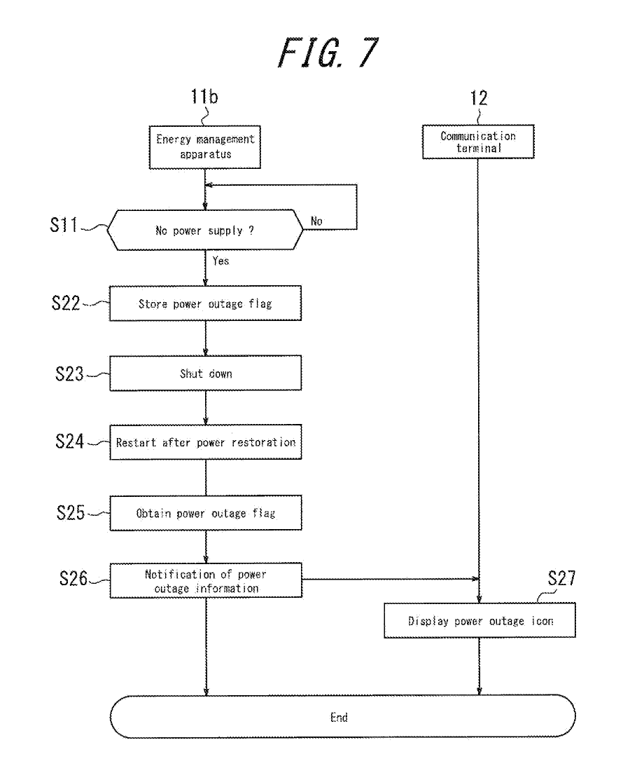

Next, an operation of the energy management system 10b according to the second embodiment will be described with reference to a flowchart illustrated in FIG. 7. Processes the same as those of the first embodiment will be denoted by the same reference signs, and descriptions thereof will be omitted.

In the energy management system 10b according to the second embodiment, when there is no power supply at step S11, the control unit 114b proceeds to step S21. On the other hand, when there is the power supply, the control unit 114b repeats step S11.

When there is no power supply at step S11, the control unit 114b of the energy management apparatus 11b determines that there is a power outage and stores the power outage flag in the storage unit 115 (step S22). At this time, the energy management apparatus 11b operates by using the power supplied from the capacitor 113, and the control unit 114b carries out the shutdown operation of the energy management apparatus 11b (step S23).

Subsequently, when the power is restored, the control unit 114b restarts the energy management apparatus 11b (step S24). After restarting the energy management apparatus 11b, the control unit 114b refers to the storage unit 115 and retrieves the power outage flag therefrom (step S25). Then, the energy management apparatus 11b notifies the communication terminal 12 by transmitting, based on the power outage flag, the power outage information about the power outage occurred in the past by using the specific code prescribed in ECHONET Lite (registered trademark) (step S26). The control unit 123 of the communication terminal 12, upon receiving the notification of the power outage information via the communication unit 124, controls the display unit 121 to display the power outage icon (step S27).

According to the second embodiment of the present invention, as described above, since the energy management apparatus 11b detects a power outage based on the absence of the power supply to the power input unit 112 and, after power restoration, notifies the communication terminal 12 of the power outage information, the communication terminal 12 may be notified of the power outage information as an appropriate measure to be taken in the event of a power outage. Also, such notification of the power outage information allows the user to recognize that there was a power outage occurred in the past and to check, for example, whether a recording program of the video deck or time setting of the air conditioning has been cancelled.

Although the energy management apparatus 11b according to the second embodiment includes the storage unit 115 for storing the power outage flag, the present invention is not restrictive thereto. The energy management apparatus 11b, instead of including the storage unit 115, may store the power outage flag in the database 25.

Also, the energy management apparatus 11b may store, in association with the power outage flag, information about time to have lost the power supply in the storage unit 115. In this case, the power outage information includes the time to have lost the power supply, and the communication terminal 12 displays the time to have lost the power supply together with the power outage icon. Thereby, the user may recognize that the power outage was occurred at the time in the past.

Although the present invention has been described based on the figures and the embodiments, it is to be understood that various modifications and changes may be implemented based on the present disclosure by those who are ordinarily skilled in the art. Accordingly, such modifications and changes are included in the scope of the present invention. For example, functions and the like included in each means, each step and the like may be rearranged without logical inconsistency, so as to combine a plurality of means or steps together or to divide them.

### REFERENCE SIGNS LIST

10, 10b energy management system
11, 11b energy management apparatus
12 communication terminal
13 smart meter
14 power conditioner
15 battery unit
16 distribution board
17 load apparatus
25 database
50 grid power source
60 system EMS
61 database
70 network
111 communication unit
112 power input unit
113 capacitor
114, 114b control unit
115 storage unit
121 display unit
122 input detection unit
123 control unit
124 communication unit

1. An energy management apparatus provided to a consumer's facility in order to manage a power state of a load apparatus or a distributed power source in the consumer's facility, the energy management apparatus comprising:
a power input unit for receiving power supply; and
a control unit, when there is no power supply to the power input unit from a grid power source, for notifying a communication terminal of power outage information.

2. The energy management apparatus according to claim 1, wherein
the power input unit receives power supply from the distributed power source when there is no power supply to the power input unit from the grid power source, and
the control unit, after start of the power supply from the distributed power source, notifies the communication terminal of the power outage information.

3. The energy management apparatus according to claim 2, wherein
the power input unit receives the power supply from the distributed power source, and
the control unit shuts down the energy management apparatus when there is no power supply to the power input unit from the grid power source, and then restarts the energy management apparatus by using the power supply from the distributed power source.

4. The energy management apparatus according to claim 3, further comprising a capacitor that is charged by using the power supply from the grid power source and having a capacity that allows for power supply at least during an operation of the shutdown.

5. The energy management apparatus according to claim 2, wherein
the power input unit receives the power supply from the distributed power source, and
the control unit, based on power outage state information from the distributed power source, notifies the communication terminal of the power outage information.

6. The energy management apparatus according to claim 1, wherein
the control unit, based on the power outage state information, further notifies the communication terminal of power restoration information.

7. The energy management apparatus according to claim 1, wherein
the control unit shuts down the energy management apparatus when there is no power supply to the power input unit from the grid power source and, after power restoration, notifies the communication terminal of the power outage information.

8. The energy management apparatus according to claim 6, further comprising a storage unit, wherein
the control unit stores a power outage flag in the storage unit during an operation of the shutdown and, after power restoration, notifies the communication terminal of the power outage information based on the power outage flag.

9. The energy management apparatus according to claim 7, further comprising a capacitor that is charged by using the power supply from the grid power source and having a capacity that allows for power supply at least during an operation of the shutdown.

10. An energy management system including an energy management apparatus provided to a consumer's facility in order to manage a power state of a load apparatus or a distributed power source in the consumer's facility and also including a communication terminal,
the energy management apparatus, when there is no power supply from a grid power source, transmitting power outage information to the communication terminal, and
the communication terminal, when receiving the power outage information, displaying an indication based on the power outage information.

11. A method of controlling an energy management system including an energy management apparatus provided to a consumer's facility in order to manage a power state of a load apparatus or a distributed power source in the consumer's facility and also including a communication terminal, the method comprising:
a step of transmitting, by the energy management apparatus, power outage information to the communication terminal when there is no power supply from a grid power source; and
a step of displaying, by the communication terminal, an indication based on the power outage information when the communication terminal receives the power outage information.
